(19) United States
(12) Patent Application Publication
(10) Pub. No.: US 2015/0026694 A1
(43) Pub. Date: Jan. 22, 2015

(54) METHOD OF PROCESSING INFORMATION, STORAGE MEDIUM, AND INFORMATION PROCESSING APPARATUS

(71) Applicant: Fujitsu Limited, Kawasaki-shi (JP)

(72) Inventor: Akira AKIYAMA, Numazu (JP)

(21) Appl. No.: 14/305,060

(22) Filed: Jun. 16, 2014

(30) Foreign Application Priority Data
Jul. 18, 2013 (JP) 2013-149835

(51) Int. Cl. G06F 12/02; G06F 9/48

(52) U.S. Cl. CPC G06F 12/0261; G06F 9/4881; G06F 2212/702; G06F 2209/5021
USPC 718/103

(57) ABSTRACT

A method of processing information includes receiving a notification indicating completion of a garbage collection processing; dividing a time period of the garbage collection processing into a plurality of intervals; calculating, for each of the plurality of intervals, an interval fill-rate by calculating a sum total of a processing time allocated to each of one or more threads, calculating a quotient by dividing the sum total by a smaller one of a number of threads and a number of cores, and dividing the quotient by an execution time; calculating an entire fill-rate by dividing, by an execution time of the entire garbage collection processing, a sum total of a product of the interval fill-rate and the execution time of the interval; and lowering a priority of a second process than a priority of the first process, when the entire fill-rate is equal to or less than a predetermined value.

### CROSS-REFERENCE TO RELATED APPLICATION

This application is based upon and claims the benefit of priority of the prior Japanese Patent Application No. 2013-149835, filed on Jul. 18, 2013, the entire contents of which are incorporated herein by reference.

### FIELD

The embodiments discussed herein are related to a method of processing information, a storage medium, and an information processing apparatus.

### BACKGROUND

In an application execution environment by a programming language, such as Java (registered trademark), or the like, a program execution environment is provided with a garbage collection (GC) function which collects objects which occupy a memory and are no longer in use, and releases the objects. Thanks to GC processing, it becomes needless to consider release processing of objects at the time of coding a program. On the other hand, when GC processing is executed, application execution is temporarily stopped, and transactions are suspended during that time period. Accordingly, an application execution speed is lowered.

In general, GC processing time is greatly influenced by the following two factors. The first one is a factor that is enclosed in a process, which derives from an application behavior, the area (heap area) size for holding objects, and the like, such as the amount of existent objects, the reference relationship thereof, and the like. If the amount of existent objects is large, or the reference relationships thereof are complicated, the GC processing time becomes long.

The second one is an external factor of the process, which derives from the execution condition of the other application processes. When GC processing is executed, if highly loaded processing is performed at the same time in background, only a smaller amount of CPU resources is allocated to the GC processing, and thus the GC processing time becomes long.

In order to reduce the GC processing time, it is desirable to grasp the influences caused by the above-described two factors. For a related technique for use in the grasping, a GC log output function, a monitoring tool, such as provided by the OS, and the like are provided. By the GC log output function, it is possible to confirm the GC processing time, and the CPU use rate of the process in execution of GC. By a monitoring tool, such as provided by the OS, and the like, it is possible to confirm the operating condition of the entire system. In order to execute the GC processing efficiently, it has to improve applications, to review the heap size tuning, the system configuration, and the like based on these pieces of information.

In order to reduce deterioration of a system execution speed caused by such GC processing, a thread scheduling method has been proposed in which time until the GC processing is started is deferred, and the amount of data automatically collected is increased. In this method, the amount of memory allocated to each thread, and the number of times for referencing data are measured, and a thread having a larger number of referencing data and a larger amount of allocated data is scheduled with priority. As a Related art, for example, Japanese Laid-open Patent Publication No. 2003-108389, and the like have been disclosed.

The above-described related technique is aimed to grasp the influence on the GC processing time by a factor enclosed in a process, and thus it is possible to study static improvements by tuning of a heap and application modification. However, by the related technique method, it is difficult to grasp external factors of a process, which are different depending on occasional circumstances of the GC execution, such as the influence of the other application processes, and the like. Accordingly, there is a problem in that it is difficult to take static measures.

For an external factor of a process, it is thought that a highly loaded state in which the other application process is executed in background, and the like is detected. If the other application process is in a highly loaded state, the GC processing time takes longer time. Thus, in such a case, countermeasures are taken to control priority such that the priority of the other application process is automatically lowered, and the CPU resources are allocated to a process executing the GC processing with priority.

In order to achieve the countermeasures, it has to grasp whether the GC processing is being influenced by the other application process or not. This is determined by a use state of the CPU. However, by an index indicating a use state of the CPU for each related-art process, it is sometimes difficult to suitably grasp the CPU resources that are actually allocated to the GC processing. Thus, it is not sufficient as a determination criterion for priority control. Accordingly, when priority is given to the GC processing, the other application process is sometimes limited needlessly.

### SUMMARY

According to an aspect of the invention, a method of processing information, executed by a processor included in an information processing apparatus, the method includes receiving a notification indicating completion of garbage collection processing from a first process among a plurality of processes executed by one or more processors in parallel; dividing a time period during which the garbage collection processing is executed into a plurality of intervals so that adjacent intervals have a different number of threads based on one or more threads executed in the first process; calculating, for each of the plurality of intervals, an interval fill-rate by calculating a sum total of a processing time of the one or more threads, the processing time being actual elapsed time from processing start to end, calculating a quotient by dividing the sum total by a smaller one of a number of threads of the interval and a number of cores of the one or more processors, and dividing the quotient by an execution time of each of the pluralities of intervals; calculating an entire fill-rate by dividing, by an execution time of the entire garbage collection processing, a sum total of a product of the interval fill-rate and the execution time of the interval calculated for each of the plurality of intervals; and lowering a priority of a second process not having executed the garbage collection processing among the plurality of processes with respect to a priority of the first process, when the entire fill-rate is equal to or less than a predetermined value and when the garbage collection processing is executed again in the first process.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of an information processing apparatus according to the present embodiment;

FIG. 2 is a diagram for explaining calculation of an entire fill-rate;

FIG. 3 is another diagram for explaining calculation of an entire fill-rate;

FIG. 4 is a schematic block diagram illustrating an example of a computer functioning as the information processing apparatus;

FIG. 5 is a diagram illustrating an example of operation of each process in the case where another process is highly loaded;

FIG. 6 is a flowchart illustrating fill-rate calculation processing according to the present embodiment;

FIG. 7 is a flowchart illustrating priority management processing according to the present embodiment;

FIG. 8 is a diagram illustrating an example of a management table;

FIG. 9 is a flowchart illustrating priority manipulation processing according to the present embodiment;

FIG. 10 is a diagram illustrating an example of operation of each process after priority control;

FIG. 11 is a diagram illustrating an example of operation of each process in the case where another process is more highly loaded; and

FIG. 12 is a diagram illustrating a comparison between a related-art index and an entire fill-rate according to the present embodiment.

### DESCRIPTION OF EMBODIMENTS

In the following, a detailed description will be given of an example of an embodiment according to the disclosed technique with reference to the drawings.

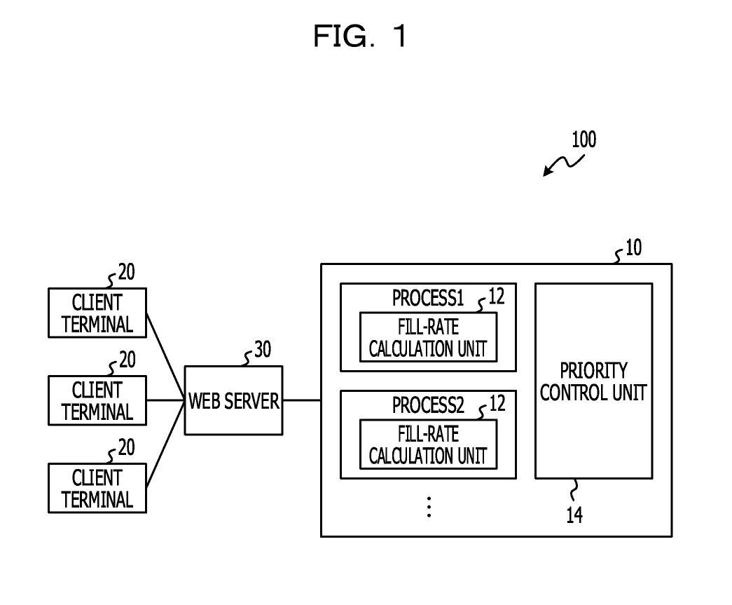

As illustrated in FIG. 1, in an information processing system 100 including a plurality of client terminals 20, a Web server 30, and an application server, it is possible to use an information processing apparatus 10 according to the present embodiment, for example, as the application server.

The information processing apparatus 10 executes a plurality of same or different applications at the same time by a CPU including a plurality of cores, or a plurality of CPUs including one core. The CPU including a plurality of cores, or the plurality of CPUs including one core is an example of the arithmetic unit according to the disclosed technique. In the information processing apparatus 10, a plurality of processes for executing individual applications are provided, respectively. In each process, a plurality of threads are executed, and CPU resources are allocated to each of the threads. The allocation of the CPU resources is determined in accordance with the priority of each process.

The information processing apparatus 10 includes a fill-rate calculation unit 12 which functions in each of the plurality of processes, and a priority control unit 14 which controls the priority of each process.

The fill-rate calculation unit 12 calculates the entire fill-rate indicating a ratio of the CPU resources actually allocated to the entire GC processing at the time of executing garbage collection (GC) processing in each process with respect to the CPU resources requested by the process for executing the GC processing.

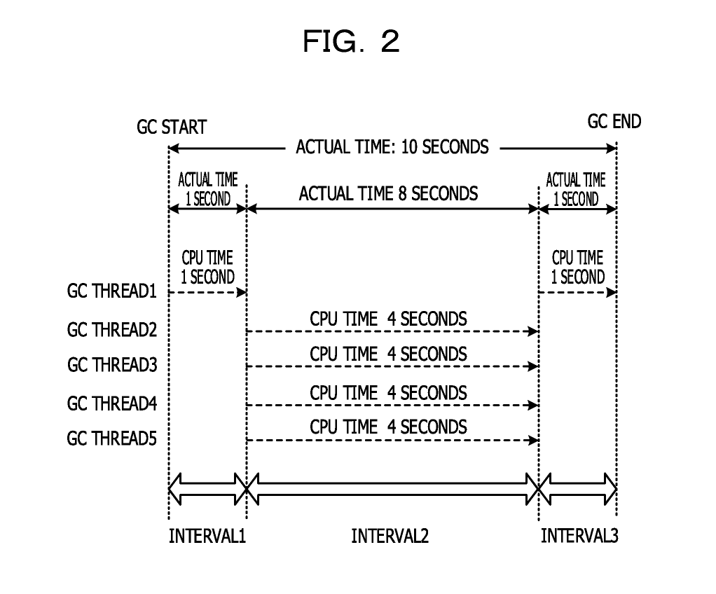

Here, as illustrated in FIG. 2 for example, the GC processing mixedly includes intervals having different numbers of operating threads, such as an interval having a single operating thread (interval 1 and interval 3 in FIG. 2), and an interval having a multiple operating threads (interval 2 in FIG. 2), and the like. For example, an interval having a single operating thread uses only one specific core. In the interval having multiple operating threads, a plurality of cores are allocated to the corresponding threads in accordance with the number of threads. Accordingly, in a related-art index, it is difficult to suitably grasp how much CPU resources have been actually allocated to the processing mixedly including intervals having different numbers of operating threads. The related-art index is an index which indicates what percentage of the CPU resources have been allocated to each process on the assumption that the entire GC processing is regarded as one interval, and which has been calculated by the “CPU time/actual time” and the “operating cycle of a processor/CPU cycle”, or the like, for example.

Thus, the fill-rate calculation unit 12 according to the present embodiment first calculates an interval fill-rate for each interval having a different number of threads in a process in which GC processing has been executed in accordance with the number of operating threads in each interval, and the number of cores included in the information processing apparatus 10. And the fill-rate calculation unit 12 calculates the entire fill-rate of the entire GC processing based on the calculated interval fill-rates.

Specifically, the fill-rate calculation unit 12 first calculates an interval fill-rate for each interval having a different number of threads in the process having executed the GC processing by the following expression (1).

The interval fill-rate [%]=(the sum total of CPU time/smaller one of the number of threads or the number of cores)/actual time*100 (1)

Here, the CPU time is a time period that CPU has been actually allocated to each thread by the OS. The actual time is the actual elapsed time of each thread from processing start to end.

In the case of a single thread, the CPU time of the single thread=the sum total of the CPU time, and the “smaller one of the number of threads or the number of cores” becomes “1”. Accordingly, it is possible to simplify the above-described expression (1) as illustrated by the following expression (2).

The interval fill-rate of a single thread [%]=the CPU time/the actual time*100 (2)

Next, the fill-rate calculation unit 12 calculates the entire fill-rate of the entire GC processing by the following expression (3).

The entire fill-rate [%]=(the sum total of (the interval fill-rate*the actual time of interval))/the actual time of the entire GC processing (3)

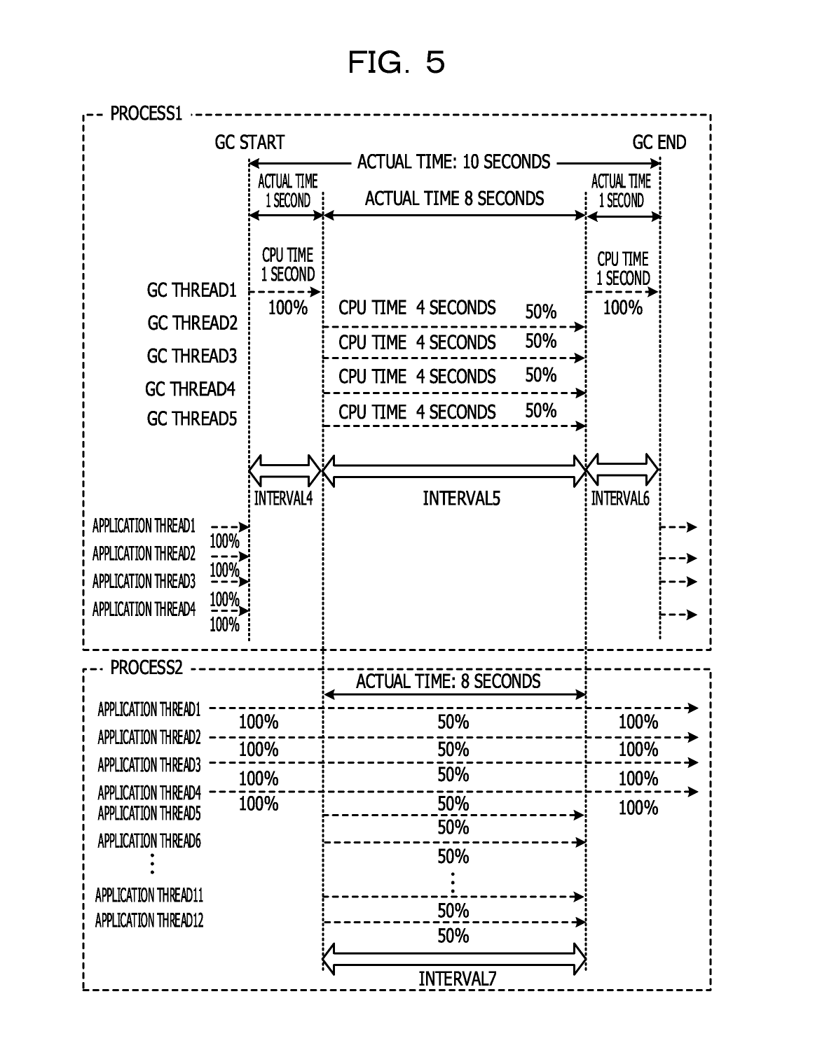

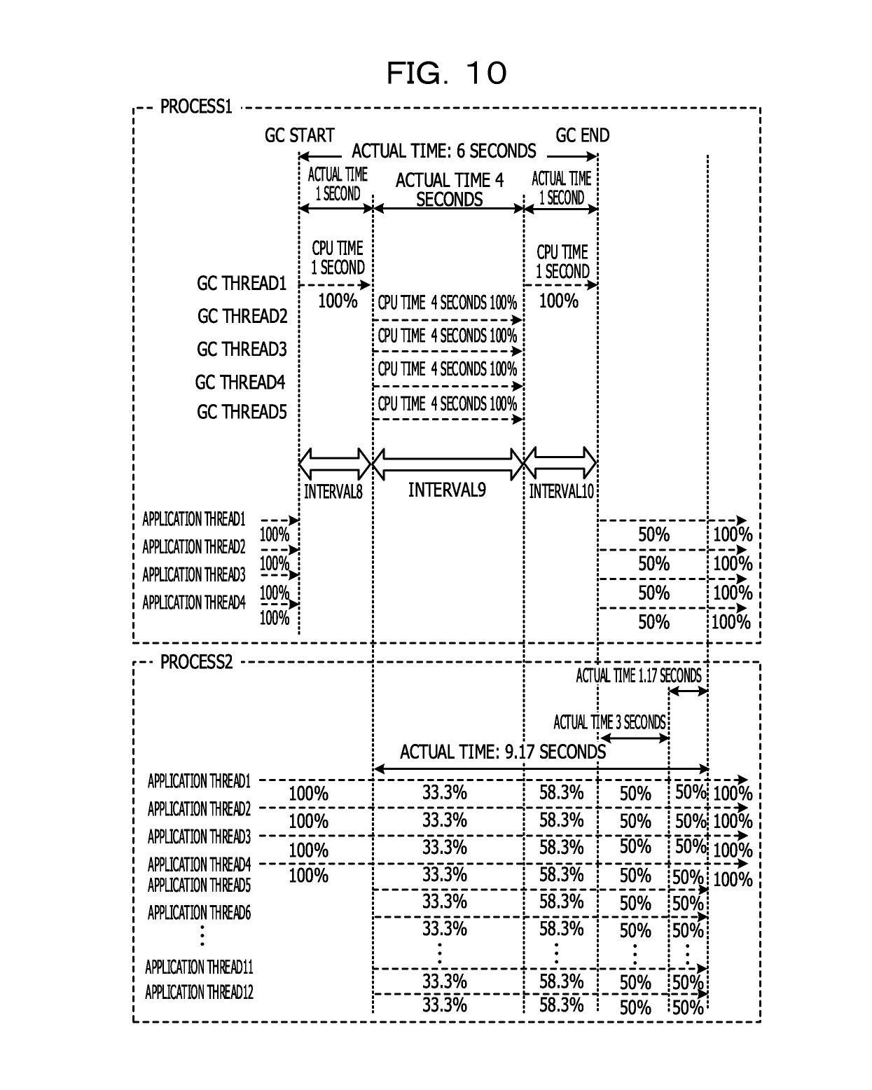

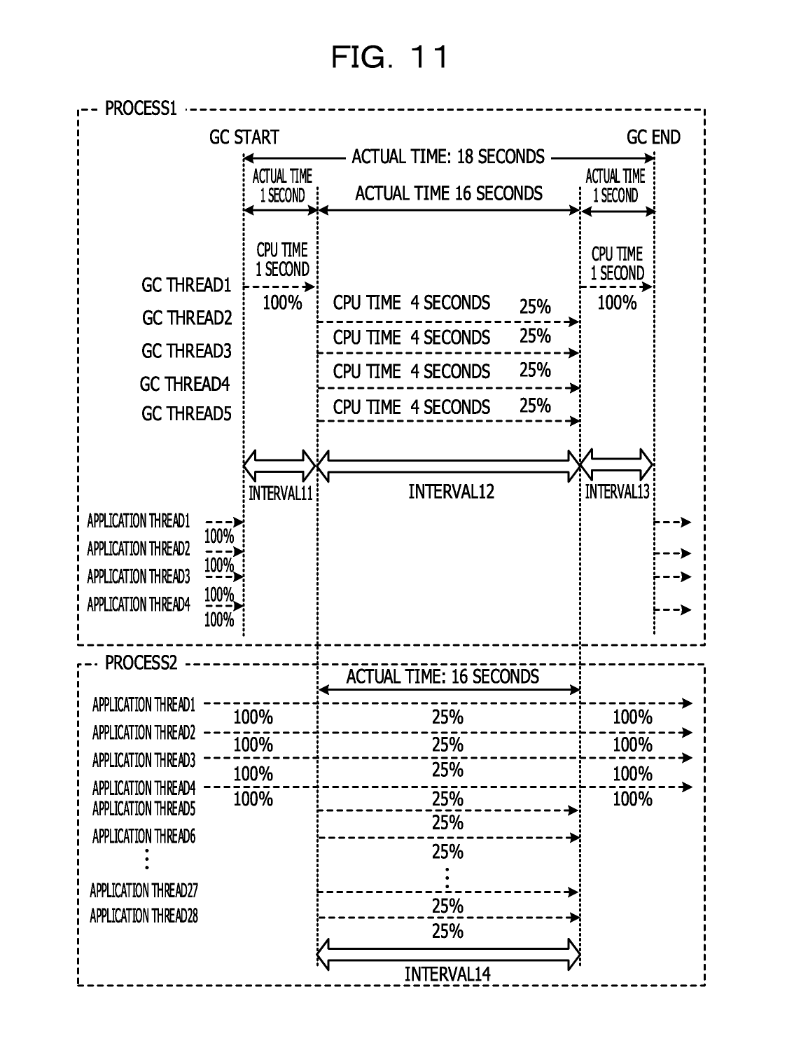

A more specific description will be given of the calculation of the entire fill-rate of the GC processing using FIG. 2. The example of the GC processing illustrated in FIG. 2 includes three intervals, that is to say, interval 1 in which only the GC thread 1 operates, interval 2 in which four threads, GC thread 2 to GC thread 5 operate at the same time, and interval 3 in which only GC thread 1 operates again. That is to say, the GC thread 1 is a phase in which only a single thread operates (the processing is not performed at the same time with the other GC threads). The GC thread 2 to GC thread 5 are processed in a phase (parallel execution interval) in which a plurality of threads operate. A dashed-line arrow corresponding to each GC thread represents an interval in which an allocation request of the CPU resources to each thread is made. The actually allocated CPU time is described above each dashed-line arrow. An interval without a dashed-line arrow represents that there is no allocation request of the CPU resources to that GC thread. The actual time of each interval is described above a solid-line arrow. This way of description is applied in the same way to FIG. 5, FIG. 10, and FIG. 11, described later.

In FIG. 2, the information processing apparatus 10 on which a CPU having four cores is mounted operates based on the assumption that the CPU resources are equally allocated to each thread.

In the example in FIG. 2, the actual time from the GC start to the GC end is 10 seconds. The CPU resources are allocated to one thread in interval 1, four threads in interval2, and one thread in interval3. In this case, the interval fill-rate of each interval is calculated by the expression (1) or the expression (2) as follows.

The interval fill-rate [%] of interval 1=the CPU time/the actual time*100=1/1*100=100[%]

The interval fill-rate [%] of interval 2=(the sum total of CPU time/smaller one of the number of threads or the number of cores)/actual time*100=(4*4/4)/8*100=50[%]

The interval fill-rate [%] of interval 3=the CPU time/the actual time*100=1/1*100=100[%]

The entire fill-rate [%]=(the sum total of (interval fill-rate*actual time of interval))/the entire actual time of GC processing=(100*1+50*8+100*1)/(1+8+1)=60[%]

The index using the CPU use rate of the entire related-art GC processing is calculated as described below.

The CPU use rate of related-art GC processing=(the sum total of the CPU time of all the threads/the number of cores)/the actual time*100 of all the GC processing=((1+4*4+1)/4)/10*100=45[%]

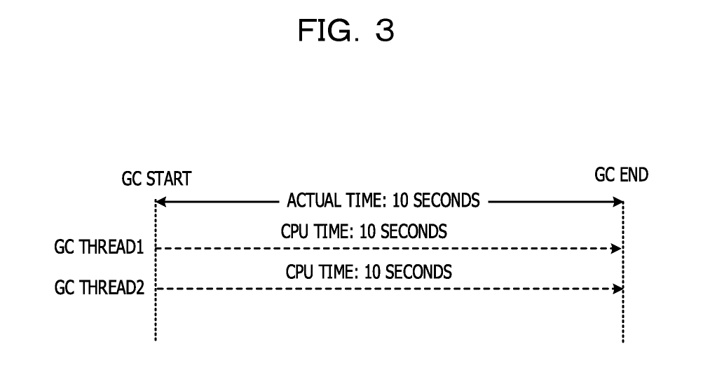

As illustrated in FIG. 3, a description will be given of an example of GC processing in which GC thread 1 and GC thread 2 having the CPU time of 10 seconds, respectively, are executed. In the GC processing in FIG. 3, the actual time of the entire GC processing is 10 seconds. The number of cores included in the information processing apparatus 10 is four in the same manner as the above-described case. In FIG. 3, the number of threads in the entire GC processing is two, and thus the entire GC processing becomes one interval. That is to say, the interval fill-rate=the entire fill-rate, and thus the entire fill-rate becomes as follows.

The entire fill-rate (=interval fill-rate) [%]=(the sum total of CPU time/smaller one of the number of threads or the number of cores)/actual time*100=(10*2/2)/10*100=100[%]

On the other hand, when the related-art CPU use rate, which is similar to the above, is calculated as follows.

The CPU use rate of related-art GC processing=(the sum total of the CPU time of all the threads/the number of cores)*the actual time of the entire GC processing*100=((10*2)/4)/10*100=50[%]

In this manner, in the related-art index, although the CPU resources are actually allocated 100%, it is difficult to suitably calculate the value. On the other hand, by the method of calculating the entire fill-rate, according to the present embodiment, it is possible to more suitably calculate the ratio of the CPU resources, which has been actually allocated.

If the entire fill-rate calculated by the fill-rate calculation unit 12 is low, it is possible to determine that the GC processing takes a long time because of the execution state of an application execution process (hereinafter, referred to as the “other process”) other than the process executing the GC processing. Thus, if the calculated fill-rate entire is a predetermined value or less, the fill-rate calculation unit 12 notifies a low fill-rate notification indicating that the CPU resources allocated at the execution time of the GC processing are insufficient to the priority control unit 14. The predetermined value is suitably determined in advance in accordance with the processing contents performed by the information processing apparatus 10 and the requested performance, and the like.

The priority control unit 14 controls the priority of each process at the time of executing the GC processing. Specifically, the priority control unit 14 monitors whether the GC processing is started or not in the process whose entire fill-rate had become a predetermined value or less at the time of executing the GC processing in the past. If the GC processing is started in the process whose entire fill-rate had become the predetermined value or less, the priority control unit 14 lowers the priority of the other processes that are executed at the same time with the process of executing the GC processing. The lowering the priorities of the other processes ought to be performed by lowering the priorities of the other processes with respect to the process that executes the GC processing. Accordingly, the priorities of the other processes themselves may be lowered, or the priorities of the processes executing the GC processing may be increased. Thereby, the CPU resources are allocated to the process executing the GC processing with priority over the other processes.

When the GC processing is completed, the priority control unit 14 returns the priority of the other processes, which has been lowered, to the state before lowering the priority.

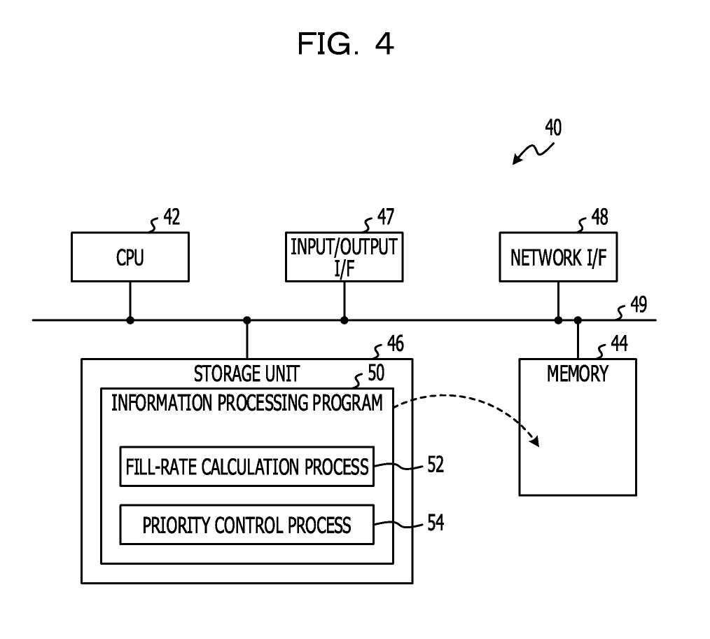

It is possible to achieve the information processing apparatus 10 by a computer 40 illustrated in FIG. 4, for example. The computer 40 includes a CPU 42, a memory 44, a nonvolatile storage unit 46, an input/output interface (I/F) 47, and a network I/F 48. The CPU 42, the memory 44, the storage unit 46, the input/output I/F47, and the network I/F 48 are mutually connected through a bus 49.

The storage unit 46 is achieved by a hard disk drive (HDD), a flash memory, and the like. The storage unit 46, as a recording medium, stores an information processing program 50 for causing the computer 40 to function as the information processing apparatus 10. The CPU 42 reads the information processing program 50 from the storage unit 46, expands the program onto the memory 44, and executes the processes included in the information processing program 50 in sequence.

The information processing program 50 includes a fill-rate calculation process 52, and a priority control process 54.

The CPU 42 executes the fill-rate calculation process 52 so as to operate as the fill-rate calculation unit 12 illustrated in FIG. 1. The CPU 42 executes the priority control process 54 so as to operate as the priority control unit 14 illustrated in FIG. 1. Thereby, the computer 40 that has executed information processing program 50 functions as the information processing apparatus 10.

It is also possible to achieve the information processing apparatus 10, for example, by a semiconductor integrated circuit, more specifically, an application specific integrated circuit (ASIC), or the like.

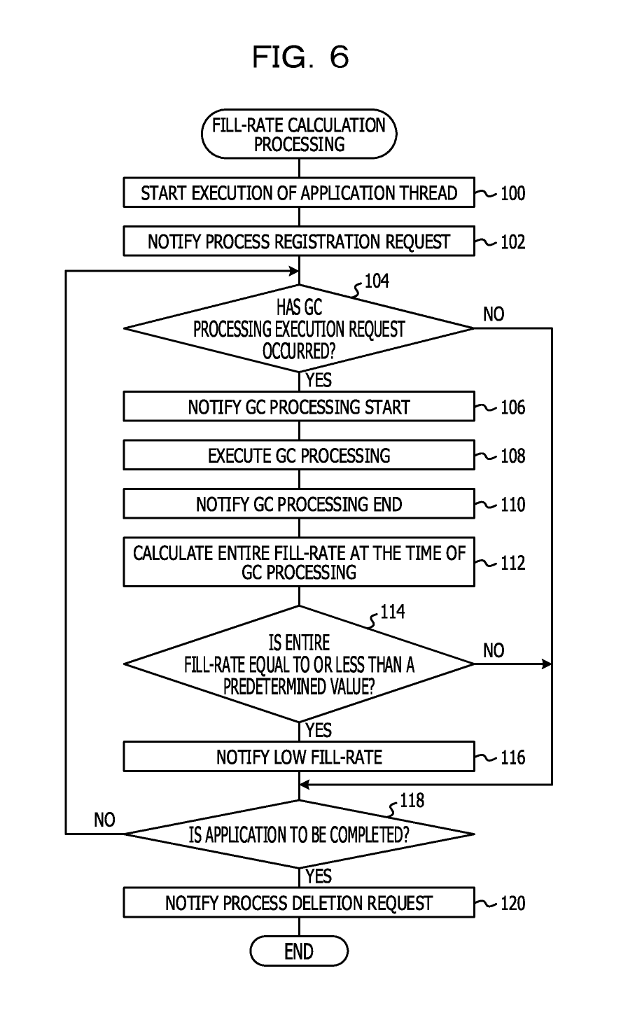

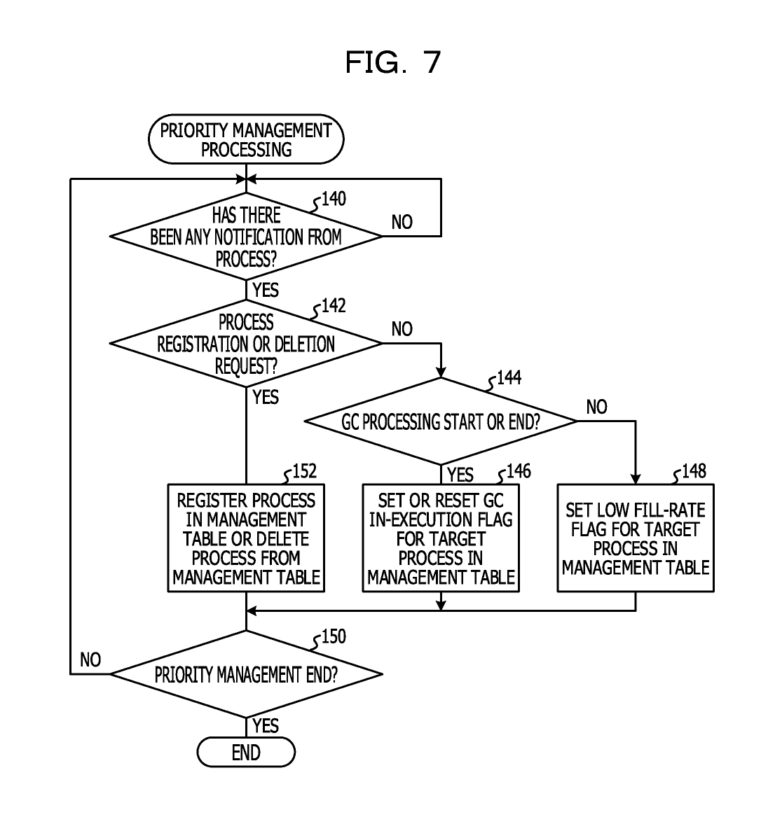

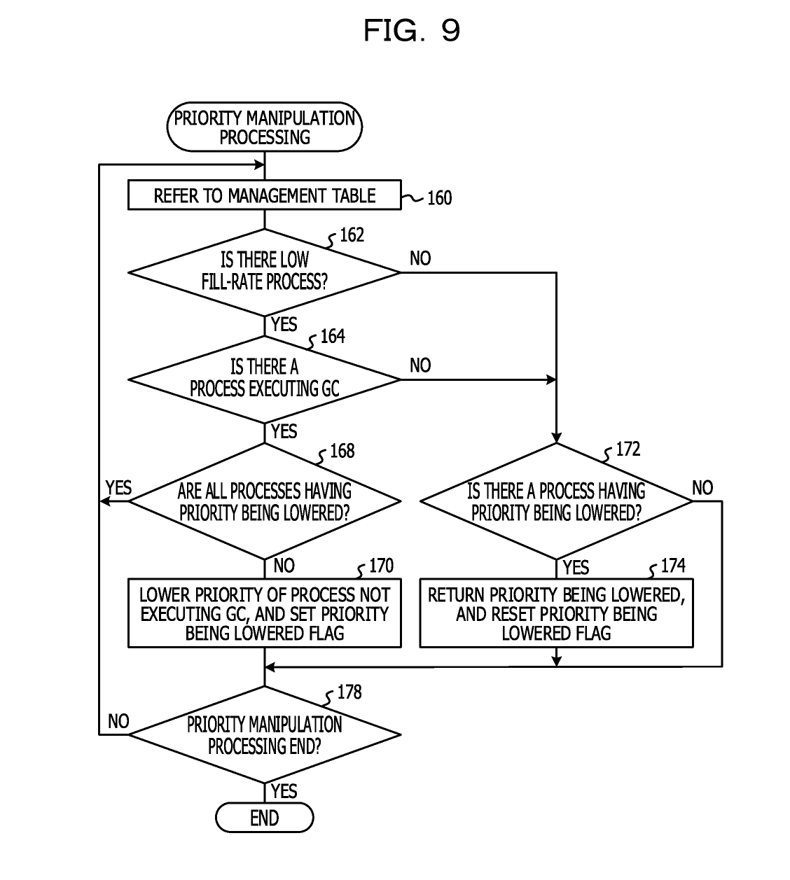

Next, a description will be given of operation of the information processing apparatus 10 according to the present embodiment. Here, as illustrated in FIG. 5, a description will be given of the case where two processes (process 1 and process 2) are executed in the information processing apparatus 10 as an example. It is assumed that the information processing apparatus 10 is provided with a CPU including eight cores, and the CPU resources are equally allocated to each thread. In the information processing apparatus 10, the fill-rate calculation processing illustrated in FIG. 6 is executed in each process. In parallel with the fill-rate calculation processing, the priority management processing illustrated in FIG. 7, and the priority control processing including the priority manipulation processing illustrated in FIG. 9 are executed in the information processing apparatus 10.

First, in step 100 of the fill-rate calculation processing illustrated in FIG. 6, in each process, execution of processing by an application thread, which performs application processing, is started. In the example in FIG. 5, in process 1, execution of the processing of application thread 1 to application thread 4 is started. And in process 2, execution of the processing by application thread 1 to application thread 4 is started.

Next, in step 102, each process notifies a process registration request for managing an application in execution in each process to the priority control unit 14.

Next, in step 104, each process determines whether an execution request of the GC processing has occurred or not. If an execution request of the GC processing has occurred, the processing proceeds to step 106. If an execution request of the GC processing has not occurred, the processing proceeds to step 118. Here, as illustrated in FIG. 5, it is assumed that an execution request of the GC processing has occurred in process 1.

In step 106, the process in which an execution request of the GC processing has occurred notifies a start of the GC processing to the priority control unit 14, and in the subsequent step 108, the GC processing is executed by a GC thread. In the example in FIG. 5, in process 1, the GC processing is executed by GC thread 1 to GC thread 5. The GC processing in process 1 illustrated in FIG. 5 has three intervals, that is to say, interval 4 in which only GC thread 1 operates, interval 5 in which four threads, namely GC thread 2 to GC thread 5 operate at the same time, and interval 6 in which only GC thread 1 operates again. While the GC processing is executed, execution of the application threads are stopped.

Next, in step 110, the process that has executed the GC processing confirmed that the GC processing has completed, and notifies the completion of the GC processing to the priority control unit 14. When the GC processing is completed, execution of the application threads is resumed.

Next, in step 112, the fill-rate calculation unit 12 in the process calculates the entire fill-rate at the time of executing the GC processing by the above-described expression (1) to expression (3). In the example in FIG. 5, at the time of executing the GC processing in process 1, application thread 5 to application thread 12 operate in interval 7 in process 2 in addition to application thread 1 to application thread 4. After that, the processing returns again to the state in which only application thread 1 to application thread 4 operate. That is to say, in the same time period of interval 5 of the GC processing in process 1, the multiplicity of the application threads increases in interval 7 in process 2, which is the other process, and process 2 is operating in a high load state.

The entire fill-rate in this case is calculated as follows.

The interval fill-rate [%] of interval 4=the CPU time/the actual time*100=1/1*100=100[%]

The interval fill-rate of interval 5 [%]=(the sum total of CPU time/smaller one of the number of threads or the number of cores)/the actual time*100=(4*4/4)/8*100=50[%]

The interval fill-rate [%] of interval 6=the CPU time/the actual time*100=1/1*100=100[%]

The entire fill-rate [%]=(the sum total of (the interval fill-rate*the interval actual time))/the actual time of the entire GC processing=(100*1+50*8+100*1)/(1+8+1)=60[%]

Next, in step 114, a determination is made of whether the entire fill-rate calculated by the fill-rate calculation unit 12 in step 112 is equal to or less than a predetermined value determined in advance or not. If the entire fill-rate is equal to or less than the predetermined value, a determination is made that allocation of the CPU resources at the time of executing the GC processing is insufficient, and the processing proceeds to step 116. Then, a low fill-rate notification is notified to the priority control unit 14, and the processing proceeds to step 118. If the entire fill-rate is higher than the predetermined value, the processing skips step 116, and proceeds to step 118.

In step 118, a determination is made of whether the application being executed in the process is to be completed or not. If the application is to be completed, the processing proceeds to step 120. Else if the application is not to be completed, the processing returns to step 104.

In step 120, a process deletion request for managing that application execution has been completed in each process is notified from each process to the priority control unit 14. And each process including the fill-rate calculation processing is completed.

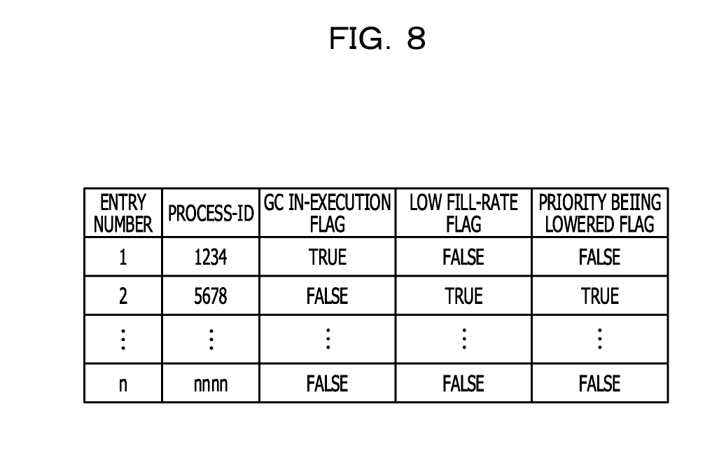

Next, a description will be given of the priority management processing illustrated in FIG. 7. The priority control unit 14 manages information desired for priority control using a management table as illustrated in FIG. 8, for example, so as to make it possible to control priority of each process. In the example in FIG. 8, the priority control unit 14 manages a GC in-execution flag indicating whether each process is in execution of the GC processing or not, and a low fill-rate flag indicating whether the process has been notified of a low fill-rate notification or not. The priority control unit 14 manages a priority being lowered flag indicating whether the process is a process having the priority lowered by the execution of the GC processing in the other process or not.

In step 140 of the priority management processing illustrated in FIG. 7, the priority control unit 14 determines whether there has been any notification from a process or not. If there has been no notification, the determination in this step is repeated until there is a notification. If there has been a notification, the processing proceeds to step 142.

In step 142, the priority control unit 14 determines whether the notification from the process is a process registration request or a process deletion request. In the case of a notification of a process registration request or a process deletion request, the processing proceeds to step 152. Else if in the case of neither notification, the processing proceeds to step 144.

In step 152, if the notification is a process registration request, the priority control unit 14 registers a process ID of the process that notified the process registration request in association with an entry number of the management table as illustrated in FIG. 8, for example. If the notification is a process deletion request, the priority control unit 14 deletes a record corresponding to the process ID of the process that has notified the process deletion request from the management table.

On the other hand, in step 144, the priority control unit 14 determines whether the notification from the process is a GC processing start or a GC processing end. In the case of the notification of a GC processing start or a GC processing end, the processing proceeds to step 146, whereas in the case of neither notification, the processing proceeds to step 148.

In step 146, if the notification is the GC processing start, the priority control unit 14 sets a GC in-execution flag corresponding to the process ID of the process that has notified the GC processing start in the management table. If the notification is the GC processing end, the priority control unit 14 resets the GC in-execution flag corresponding to the process ID of the process that has notified the GC processing end in the management table.

On the other hand, in step 148, the priority control unit 14 determines that the notification is a low fill-rate notification, and sets a low fill-rate flag corresponding to the process ID of the process that has notified the low fill-rate notification in the management table.

Next, in step 150, the priority control unit 14 determines whether a stop request of the priority management processing has occurred or not. If the stop request has not occurred, the processing returns to step 140. Else if the stop request has occurred, the priority management processing is completed.

Next, in step 160 of priority manipulation processing illustrated in FIG. 9, the priority control unit 14 refers to the management table. Next, in step 162, the priority control unit 14 determines whether there is a process having the low fill-rate flag in a set state. If there is a process, the processing proceeds to step 164. If there is not a process, the processing proceeds to step 172.

In step 164, the priority control unit 14 determines whether there is a process having the GC in-execution flag in a set state among processes having the low fill-rate flag in a set state. If there is a process, the processing proceeds to step 168. If there is not a process, the processing proceeds to step 172.

In step 168, a determination is made of whether the priority being lowered flag is set in a process other than the processes having the low fill-rate flag and the GC in-execution flag in a set state. If the priority being lowered flag is set in all the other processes, the processing returns to step 160. If there is a process having the priority being lowered flag not in a set state among the other processes, the processing proceeds to step 170.

In step 170, the priority control unit 14 lowers the priorities of the processes other than the process having the low fill-rate flag and the GC inexecution flag in a set state, and having the priority being lowered flag in a reset state. At the same time, the priority control unit 14 sets the priority being lowered flag, and the processing proceeds to step 178.

On the other hand, in step 172, a determination is made of whether there is a process having the priority being lowered flag in a set state. If there is a process, the processing proceeds to step 174, the priority of the process having the priority being lowered flag in a set state is returned to the original priority, the priority being lowered flag is reset, and the processing proceeds to step 178. If there is no process having the priority being lowered flag in a set state, the processing skips step 174, and the processing proceeds to step 178.

In step 178, the priority control unit 14 determines whether a stop request of the priority manipulation processing has occurred or not. If a stop request has not occurred, the processing returns to step 160. If a stop request has occurred, the priority manipulation processing is completed.

FIG. 10 illustrates operating states of threads in process 1 and process 2 at the time when the priority of process 2 is lowered at about the second execution time of the GC processing in process 1. For comparison, it is assumed that the processing states of the process 1 and process 2 illustrated in FIG. 10 have become the same states as those in FIG. 5.

In the example in FIG. 10, in the same time period as interval 9 in process 1, the multiplicity of the application threads in process 2 is increased, and thus the processing results in a high load state. However, in the GC processing execution interval in process 1, the CPU resources are allocated with priority, and thus 100% of the CPU resources are individually allocated to GC thread 2 to GC thread 5, for example. Thereby, the actual time of interval 9, which was 8 seconds before the priority control, becomes 4 seconds, and thus the actual time of the entire GC processing (interval 8, interval 9, and interval 10) becomes 6 seconds. Accordingly, it is possible to shorten the GC processing time. The entire fill-rate of the entire GC processing becomes 100% as illustrated below, and the processing becomes a state in which there is no influence from the other background applications.

The interval fill-rate [%] of interval 8=the CPU time/the actual time*100=1/1*100=100[%]

The interval fill-rate [%] of interval 9=(the sum total of CPU time/smaller one of the number of threads or the number of cores)/the actual time*100=(4*4/4)/4*100=100[%]

The interval fill-rate [%] of interval 10=the CPU time/the actual time*100=1/1*100=100[%]

The entire fill-rate [%]=(the sum total of (the interval fill-rate*the interval actual time))/the actual time of the entire GC processing=(100*1+100*4+100*1)/(1+4+1)=100[%]

For the example in FIG. 10, the index using the CPU use rate of the entire related-art GC processing is calculated to be 37.5% as described below. However, it is difficult to determine whether the other application has influenced or not based on this index.

The CPU use rate of related-art GC processing=(the sum total of the CPU time of all the threads/the number of cores)/the actual time of the entire GC processing*100=((1+4*4+1)/8)/6*100=37.5[%]

For process 2, application thread 5 to application thread 12 operate in the same time period as interval 9, and becomes a high load state. However, the CPU resources are allocated to process 1 with priority, and thus the CPU use rate of process 2 temporarily becomes about 33.3% (50% before priority control in the case of FIG. 5). However, the CPU resources are allocated to process 1 so that the GC processing time in process 1 is shortened, and thus the period in which the priority of process 2 is lowered does not become so long. Accordingly, the actual time of the processing of application thread 5 to application thread 12 is about 9.17 seconds (8 seconds before priority control in the case of FIG. 5), and thus process 2 is not influenced so much.

For the example in FIG. 5, the index using the CPU use rate of the entire related-art GC processing is calculated as described below.

The CPU use rate of related-art GC processing=(the sum total of the CPU time of all the threads/the number of cores)/the actual time of the entire GC processing*100=((1+4*4+1)/8)/10*100=22.5[%]

FIG. 11 illustrates an example in which process 2, the other process, is operating at higher load than in the case of FIG. 5. The example in FIG. 11 illustrates operating states of the threads in process 1 and process 2 at about the GC processing execution time in process 1 in the same manner as FIG. 5.

In the same manner as the example in FIG. 5, first, application thread 1 to application thread 4 are operating in process 1, the GC processing by GC thread 1 to GC thread 5 are executed in the middle, and application thread 1 to application thread 4 are operating again after the GC processing end. In process 2, in a state in which application thread 1 to application thread 4 are operating, more application threads than in the case of FIG. 5, that is to say, application thread 5 to application thread 28 operate in the same time period as interval 12 in process 1. After that, the processing returns to the sate in which application thread 1 to application thread 4 are operating again.

In the example in FIG. 11, in the same time period as interval 12 in process 1, the multiplicity of the application threads in interval 14 in process 2 is increased, and thus the processing results in a high load state. In interval 12, only 25% of the CPU resources are individually allocated to GC thread 2 to GC thread 5. The entire fill-rate of the entire GC processing (interval 10, interval 11, and interval 12) becomes 33.3% as described below.

The interval fill-rate [%] of interval 11=the CPU time/the actual time*100=1/1*100=100[%]

The interval fill-rate [%] of interval 12=(the sum total of the CPU time/smaller one of the number of threads or the number of cores)/the actual time*100=(4*4/4)/16*100=25[%]

The interval fill-rate [%] of interval 13=the CPU time/the actual time*100=1/1*100=100[%]

The entire fill-rate [%]=(the sum total of (the interval fill-rate*the interval actual time))/the actual time of the entire GC processing=(100*1+25*16+100*1)/(1+16+1)=33.3[%]

For the example in FIG. 11, the index using the CPU use rate of the entire related-art GC processing is calculated as 12.5% as described below.

The CPU use rate of related-art GC processing=(the sum total of the CPU time of all the threads/the number of cores)/the actual time*100 of the entire GC processing=((1+4*4+1)/8)/18*100=12.5[%]

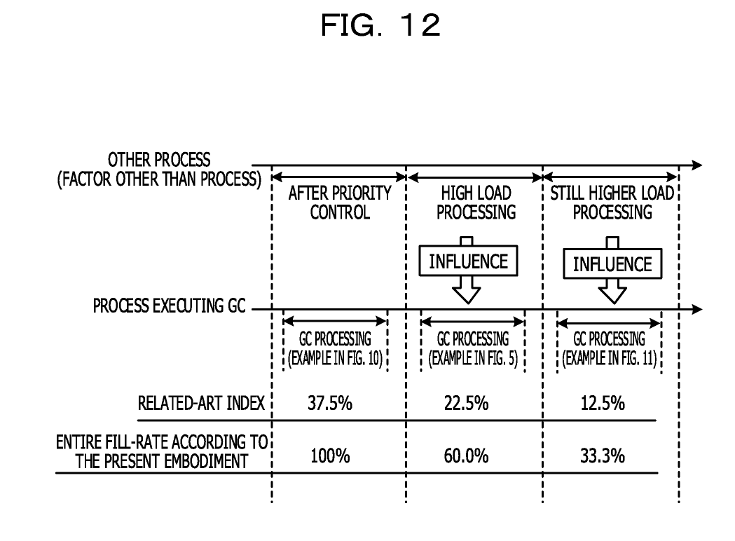

A comparison between the entire fill-rate calculated by the method according to the present embodiment in the examples in FIG. 5, FIG. 10, and FIG. 11, and the related-art index (the CPU use rate) is summarized in FIG. 12.

Here, for example, in the case where importance is attached to not limiting the priority of the other process needlessly, or the like, it is possible to set a predetermined value for determining whether the low fill-rate or not (for example, a predetermined value=50%) to a lower value. In such a case, the related-art index is calculated lower than the values of the actual allocation of the CPU resources in both examples in FIG. 5 and FIG. 11, and thus a determination is made that the fill-rate is low in both of the cases. Accordingly, there is a possibility that the priority of the other process is lowered, and the other processes are restricted needlessly.

On the other hand, in the present embodiment, it is possible to suitably calculate the entire fill-rate, for example, the entire fill-rate is 60% in the case where the other process is highly loaded as illustrated in FIG. 5, and the entire fill-rate is 33.3% in the case where the other process is still highly loaded as illustrated in FIG. 11. Accordingly, it is possible to grasp the influence of the other processes more suitably, and thus it is possible to control the priority so as to execute the GC processing efficiently without restricting the other processes needlessly.

In the above, a description has been given of the case where the low fill-rate notification is notified to the priority control unit 14 when the fill-rate calculation unit 12 has determined that the entire fill-rate is equal to or less than a predetermined value. However, the present disclosure is not limited to this. For example, the fill-rate calculation unit 12 may notify all the calculated entire fill-rates to the priority control unit 14, the priority control unit 14 may determine whether the entire fill-rates are equal to or less than a predetermined value, and the priority control unit 14 may set the low fill-rate flags of the processes that have notified the entire fill-rates of the predetermined value or less in the management table.

In the above, a description has been given of the mode in which the information processing program 50, which is an example of the information processing program according to the disclosed technique, is stored (installed) in the storage unit 46 in advance. However, it is possible to provide the information processing program according to the disclosed technique in the form of a recording medium, such as a CD-ROM, a DVD-ROM, or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of processing information, executed by a processor included in an information processing apparatus, the method comprising:
receiving a notification indicating completion of garbage collection processing from a first process among a plurality of processes executed by one or more processors in parallel;
dividing a time period during which the garbage collection processing is executed into a plurality of intervals so that adjacent intervals have a different number of threads based on one or more threads executed in the first process;
calculating, for each of the plurality of intervals, an interval fill-rate by calculating a sum total of a processing time of the one or more threads, the processing time being actual elapsed time from processing start to end, calculating a quotient by dividing the sum total by a smaller one of a number of threads of the interval and a number of cores of the one or more processors, and dividing the quotient by an execution time of each of the pluralities of intervals;
calculating an entire fill-rate by dividing, by an execution time of the entire garbage collection processing, a sum total of a product of the interval fill-rate and the execution time of the interval calculated for each of the plurality of intervals; and
lowering a priority of a second process not having executed the garbage collection processing among the plurality of processes than a priority of the first process, when the entire fill-rate is equal to or less than a predetermined value and when the garbage collection processing is executed again in the first process.

2. The method of processing information according to claim 1,
wherein the lowering the priority of the second process includes lowering the priority of the second process when a notification indicating execution of the garbage collection processing is received from the first process having the entire fill-rate equal to or less than a predetermined value.

3. The method of processing information according to claim 2, further comprising controlling so as to return the priority of the second process to a state before execution of the garbage collection processing when a notification indicating completion of execution of the garbage collection processing is received from the first process having the entire fill-rate equal to or less than a predetermined value.

4. The method of processing information according to claim 1,
wherein based on a first identifier indicating whether the entire fill-rate is equal to or less than a predetermined value, and a second identifier indicating whether the garbage collection processing is in execution or not, the lowering the priority of the second process includes lowering the priority of the second process when determined that the first process having the entire fill-rate equal to or less than a predetermined value, and in execution of the garbage collection processing is existent among the plurality of processes.

5. The method of processing information according to claim 4,
wherein the lowering the priority of the second process includes lowering the priority of the second process having the priority not lowered, and not in execution of the garbage collection processing based on the second identifier and a third identifier indicating whether a process whose priority has been lowered or not.

6. The method of processing information according to claim 5, further comprising:
when it is determined that a process having the entire fill-rate equal to or less than a predetermined value does not exist as a result of referring to the first identifier and a process having the priority lowered exists in the plurality of processes as a result of referring to the third identifier,
returning the priority of the process having the priority lowered, and
updating the third identifier corresponding to the process having the priority lowered to an identifier indicating the process having the priority not lowered.

7. The method of processing information according to claim 5,
when it is determined that a process in execution of the garbage collection processing does not exist as a result of referring to the second identifier and a process having the priority lowered exists in the plurality of processes as a result of referring to the third identifier,
returning the priority of the process having the priority lowered, and
updating the third identifier corresponding to the process having the priority lowered to an identifier indicating the process having the priority not lowered.

8. A non-transitory computer-readable storage medium storing a program causing a computer to execute a process, the process comprising:
receiving a notification indicating completion of garbage collection processing from a first process among a plurality of processes executed by one or more processors in parallel;
dividing a time period during which the garbage collection processing is executed into a plurality of intervals so that adjacent intervals have a different number of threads based on one or more threads executed in the first process;
calculating, for each of the plurality of intervals, an interval fill-rate by calculating a sum total of a processing time of the one or more threads, the processing time being actual elapsed time from processing start to end, calculating a quotient by dividing the sum total by a smaller one of a number of threads of the interval and a number of cores of the one or more processors, and dividing the quotient by an execution time of each of the pluralities of intervals;
calculating an entire fill-rate by calculating a quotient produced by dividing, by execution time of the entire garbage collection processing, a sum total of a product of the interval fill-rate and the execution time of the interval calculated for each of the plurality of intervals; and
lowering a priority of a second process not having executed the garbage collection processing among the plurality of processes than a priority of the first process when the entire fill-rate is equal to or less than a predetermined value and when the garbage collection processing is executed again in the first process.

9. The storage medium according to claim 8,
wherein the lowering the priority of the second process includes lowering the priority of the second process when a notification indicating execution of the garbage collection processing is received from the first process having the entire fill-rate equal to or less than a predetermined value.

10. The storage medium according to claim 9, further comprising controlling so as to return the priority of the second process to a state before execution of the garbage collection processing when a notification indicating completion of execution of the garbage collection processing is received from the first process having the entire fill-rate equal to or less than a predetermined value.

11. The storage medium according to claim 8,
wherein based on a first identifier indicating whether the entire fill-rate is equal to or less than a predetermined value, and a second identifier indicating whether the garbage collection processing is in execution or not, the lowering the priority of the second process includes lowering the priority of the second process when determined that the first process having the entire fill-rate equal to or less than a predetermined value, and in execution of the garbage collection processing is existent among the plurality of processes.

12. The storage medium according to claim 11,
wherein the lowering the priority of the second process includes lowering the priority of the second process having the priority not lowered, and not in execution of the garbage collection processing based on the second identifier and a third identifier indicating whether a process whose priority has been lowered or not.

13. An information processing apparatus comprising:
a memory; and
a processor coupled to the memory and configured to:
receive a notification indicating completion of garbage collection processing from a first process among a plurality of processes executed by one or more processors in parallel;
divide a time period during which the garbage collection processing has been executed into a plurality of intervals so that adjacent intervals have a different number of threads based on one or more threads executed in the first process;
calculate, for each of the plurality of intervals, an interval fill-rate by calculating a sum total of a processing time of the one or more threads, the processing time being actual elapsed time from processing start to end, calculating a quotient by dividing the sum total by a smaller one of a number of threads of the interval and a number of cores of the one or more processors, and dividing the quotient by an execution time of each of the pluralities of intervals
calculate an entire fill-rate by calculating a quotient produced by dividing, by execution time of the entire garbage collection processing, a sum total of a product of the interval fill-rate and the execution time of the interval calculated for each of the plurality of intervals; and
lower a priority of a second process not having executed the garbage collection processing among the plurality of processes than a priority of the first process when the entire fill-rate is equal to or less than a predetermined value and when the garbage collection processing is executed again in the first process.

14. The information processing apparatus according to claim 13, wherein the memory is configured to store
a first identifier indicating whether the entire fill-rate is equal to or less than a predetermined value,
a second identifier indicating whether the garbage collection processing is in execution or not, and
a third identifier indicating whether a process whose priority has been lowered or not in association with each of the plurality of processes, and
the processor is configured to lower the priority of the first process having the priority not lowered, and not in execution of the garbage collection processing based on the third identifier when determined that a process having the entire fill-rate equal to or less than a predetermined value is existent, and a process in execution of the garbage collection processing is existent in the plurality of processes based on the first identifier and the second identifier.
